(19) United States
(12) Patent Application Publication
(10) Pub. No.: US 2009/0271173 A1
(43) Pub. Date: Oct. 29, 2009

(54) Simulating method for loading different operation systems by means of externally connected simulation and a simulation device thereof

(76) Inventor: Wilhelm Vnukov, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/379,269

(22) Filed: Feb. 18, 2009

(30) Foreign Application Priority Data
Apr. 25, 2008 (TW) 097115349
Jul. 31, 2008 (TW) 097128975

(51) Int. Cl. G06F 9/455

(52) U.S. Cl. 703/27; 713/2

(57) ABSTRACT

A simulating method for loading different operation systems by means of externally connected simulation and a simulation device thereof. The simulating method and the simulation device are achieved by means of hardware. The simulation device can be externally inserted to a personal computer, enabling the personal computer to simulate different operation systems without being incautiously damaged by a user.

### BACKGROUND OF THE INVENTION

1. Field of the Invention

The present invention is related to a simulating method for loading different operation systems by means of externally connected simulation and a simulation device thereof. The simulating method and the simulation device enable a personal computer to simulate different operation systems without being incautiously damaged by a user.

2. Description of the Prior Art

The personal computers on current market can be divided into X86 family, Macintosh OSX family, OpenLinux family, etc. In addition, there are PS1 and PS2 family game players manufactured by Japanese Sony Company and xBox family game players manufactured by American MicroSoft Company specifically for games. The personal computers and game players respectively have their own basic input/output systems (BIOS). These systems are incompatible with each other. However, a simulator can be added to a system to simulate another personal computer or game player for use. Also, a game player can simulate a personal computer for use.

The current operators always write software as the simulator. The software is loaded into the memory of the equipment for use. However, in use, the simulator software in the memory is likely to be negligently damaged due to formatting operation. Also, when changing magnetic section or repartitioning magnetic section, the simulator software tends to be damaged.

### SUMMARY OF THE INVENTION

It is therefore a primary object of the present invention to provide a simulating method for loading different operation systems by means of externally connected simulation and a simulation device thereof. The simulating method serves to prepare a simulation device, which can be externally inserted to a personal computer to simulate different operation systems. The simulating method includes steps in which:

(1) the personal computer is booted;

(2) the basic input/output system (BIOS) of the personal computer is started;

(3) by means of the BIOS, the hardware-based simulation device is started, the simulation device being externally inserted to the personal computer to simulate different boot environment so as to load another different operation system;

(4) the hardware-based simulation device simulates a set boot environment;

(5) the hardware-based simulation device is used to boot; and

(6) the necessary operation system is executed.

In the above simulating method for loading different operation systems by means of externally connected simulation, the simulating method is achieved by means of hardware.

It is a further object of the present invention to provide an externally connected simulation device for loading different operation systems. The simulation device includes: a hardware-based boot environment simulator for simulating necessary boot environment by means of hardware; and a hardware-based operation system installation environment simulator for simulating necessary operation system installation environment by means of hardware.

In the above externally connected simulation device for loading different operation systems, the simulation device is achieved by means of hardware.

The simulating method of the present invention selectively includes steps of: taking out from advanced configuration & power interface (ACPI) of the system; copying from the ACPI; modifying all contents of differentiated system description table (DSDT); correcting the ACPI; displaying new location of the ACPI.

In the above simulating method of the present invention, when accessories do not exist in virtual kernel model, a certain driver model makes a command that the selected kernel model and the virtual kernel model are required to be loaded into another location or device so as to solve the problem that the accessories do not exist in the kernel model.

The simulating method selectively directly real-time reads or accesses the data on the hard disc for modification or writing and reads the boot table, whereby all the boot partition types of the computer can be directly displayed without making any action to the hardware.

In the above simulating method of the present invention, when the simulation device is installed on an operation system for use, a sequence of serial numbers are first sent to the operation system, the serial number of the operation system being registered in the simulation device, whereby when replacing the operation system with a new one, the same simulation device can be reinstalled on the new operation system for use.

In the above simulating method of the present invention, before loading the operation system, a special loader loads steps in which:

The non-uniformity between the OS and the ACPI in synchronous operation is corrected, this including steps of:

(a) initiating the investigation of the root system description pointer (RSDP) table within a special range of the RSDP address, these being 0xe0000-0xfffff of special boot address in the memory;

(b) finding the root system description table (RSDT) in the RSDP table;

(c) finding fixed ACPI description table (FADT) in the RSDT; and

(d) finding DSDT in the FADT;
1. in the memory, the covered range is the DSDT covered by the DSDT; and
2. after the DSDT is covered, the kernel of the OS reads the corrected ACPI table when installed.

The present invention can be best understood through the following description and accompanying drawings wherein:

### BRIEF DESCRIPTION OF THE DRAWINGS

FIG. 1 is a block diagram of the externally connected simulation device for loading different operation systems of the present invention;

FIG. 2 is a block first-stage working flow chart of the present invention;

FIG. 3 is a block second-stage working flow chart of the present invention;

FIG. 4 is a block hardware working flow chart of the present invention, showing that the present invention is able to simulate any hardware boot; and

FIG. 5 is a block working flow chart of the present invention, showing that the present invention simulates an externally connected hardware device.

### DETAILED DESCRIPTION OF THE PREFERRED EMBODIMENTS

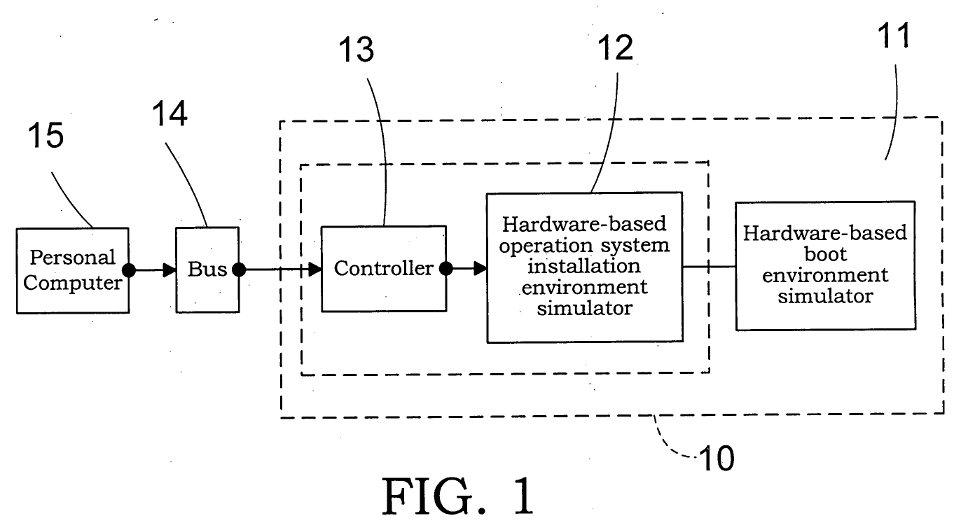

Please refer to FIGS. 1 to 5. The present invention provides a simulating method for loading different operation systems by means of externally connected simulation and a simulation device thereof. The simulating method serves to prepare a simulation device, which can be externally inserted to a personal computer to simulate different operation systems. The simulating method of the present invention includes steps in which:

(1) the personal computer is booted;

(2) the basic input/output system (BIOS) of the personal computer is started;

(3) by means of the BIOS, the hardware-based simulation device is started, the simulation device being externally inserted to the personal computer to simulate different boot environment so as to load another different operation system;

(4) the hardware-based simulation device simulates a set boot environment;

(5) the hardware-based simulation device is used to boot; and

(6) the necessary operation system is executed.

The simulating method for loading different operation systems by means of external connection of the present invention is achieved by means of hardware.

Referring to FIG. 1, the externally connected simulation device 10 for loading different operation systems of the present invention includes a hardware-based boot environment simulator 11 for simulating necessary boot environment by means of hardware, a hardware-based operation system installation environment simulator 12 for simulating necessary operation system installation environment by means of hardware, and a controller 13 connected to a personal computer 15 via a bus 14.

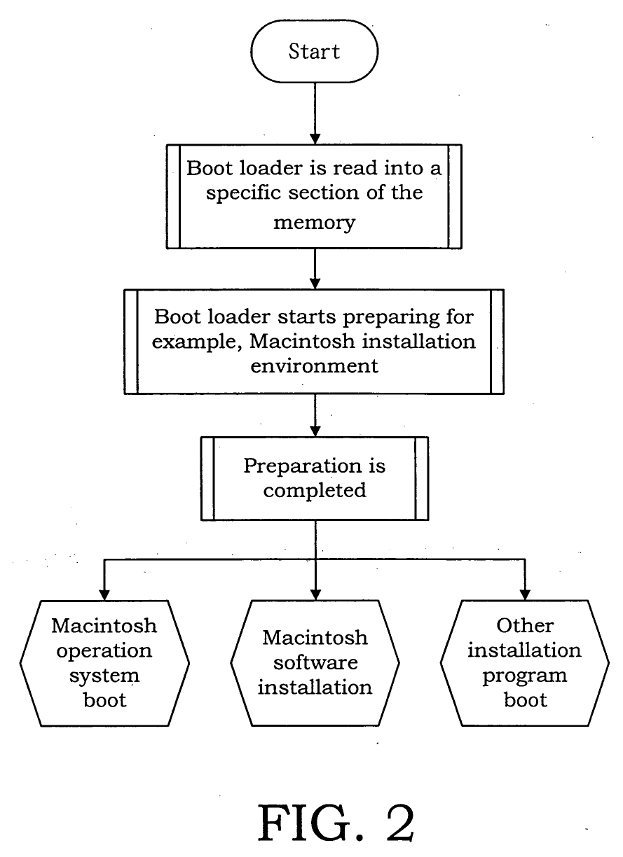

FIG. 2 is a first-stage working flow chart of the present invention, showing actual contents of the hardware-based boot environment simulator 11. After started, the boot loader is read into a specific section of the memory. Then, the boot loader starts preparing, for example, Macintosh installation environment. After the preparation is completed, a user can select Macintosh operation system boot, Macintosh software installation or other installation program boot.

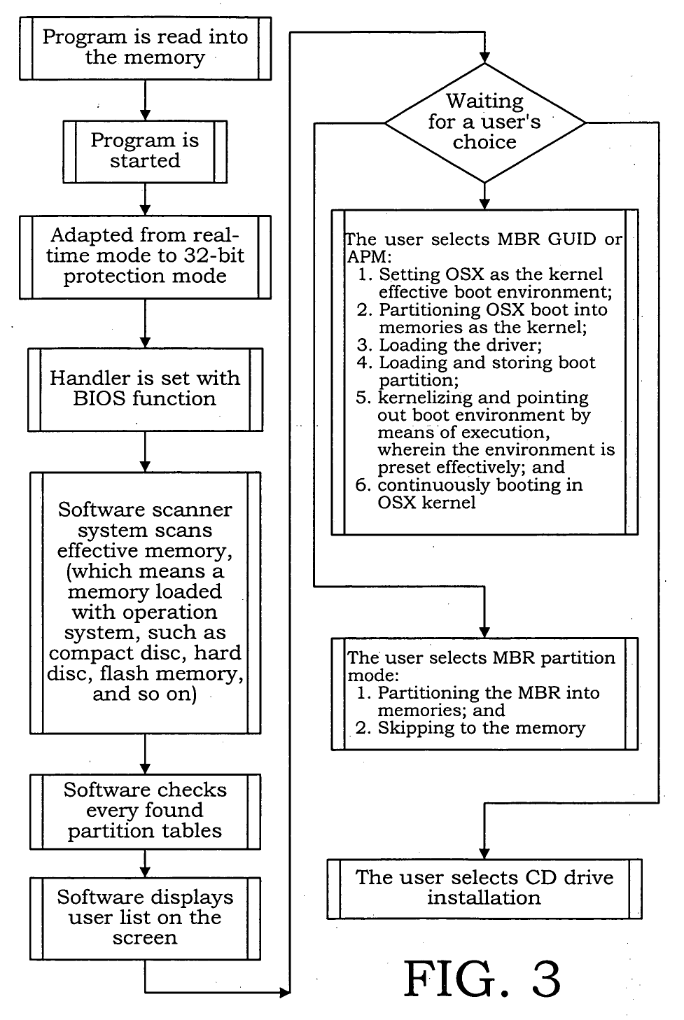

FIG. 3 is a second-stage working flow chart of the present invention, showing actual contents of the hardware-based operation system installation environment simulator 12. The program is read into the memory. The program is started and adapted from real-time mode to 32-bit protection mode. Then the handier is set with BIOS function. The software scanner system scans effective memory, (which means a memory loaded with operation system, such as compact disc, hard disc, flash memory, and so on). Then the software checks every found partition tables and then the software displays user list on the screen. The user then makes his/her choice according to the options as follows:

(1) The user selects master boot record (MBR) partition mode:
1. partitioning the MBR into memories.
2. skipping to the memory.

(2) The user selects MBR GUID or Apple Partition Map (APM):
1. setting OSX as the kernel effective boot environment.
2. partitioning OSX boot into memories as the kernel.
3. loading the driver.
4. loading and storing boot partition.
5. kernelizing and pointing out boot environment by means of execution, wherein the environment is preset effectively.
6. continuously booting in OSX kernel.

(3) The user selects CD drive installation.

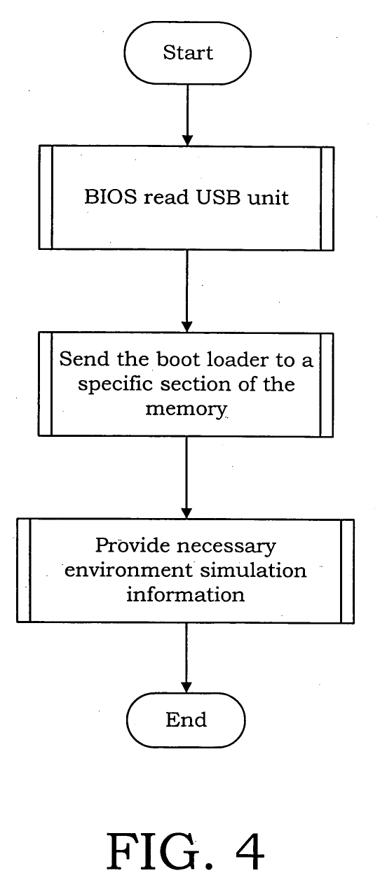

FIG. 4 is a hardware working flow chart of the present invention, showing that the present invention is able to simulate any hardware boot. After started, the BIOS reads universal serial bus (USB) unit and then sends the boot loader to a specific section of the memory to provide necessary environment simulation information. Then the work ends.

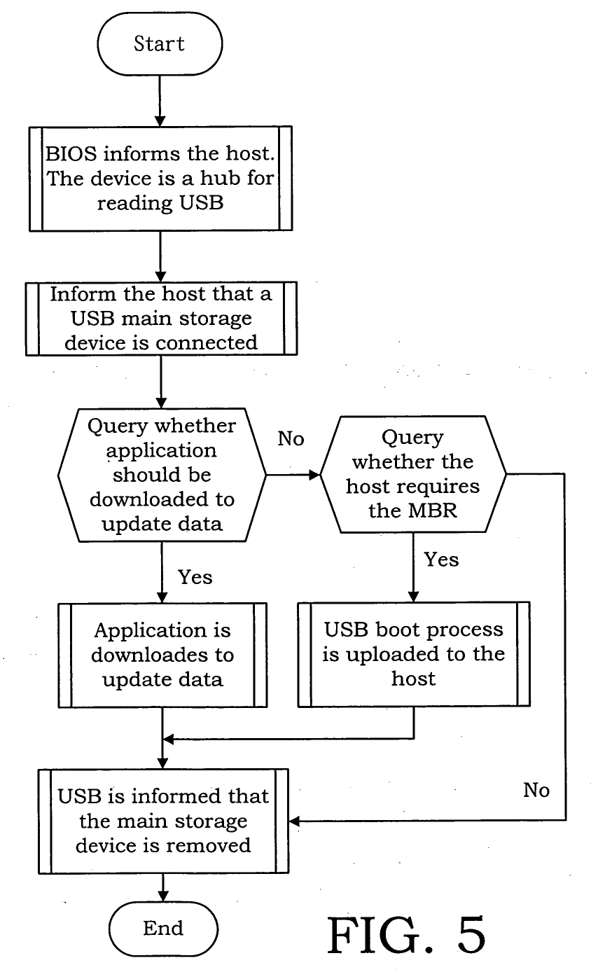

FIG. 5 is a working flow chart of the present invention, showing that the present invention simulates an externally connected hardware device. After started, the BIOS informs the host. The device is a hub for reading USB. The BIOS informs the host that a USB main storage device is connected and queries whether application should be downloaded to update data. If so, the application is downloaded to update data. If not, it is queried whether the host requires the MBR. If so, the USB boot process is uploaded to the host and then the USB is informed that the main storage device is removed. Then the work ends. If not, the USB is informed that the main storage device is removed. Then the work ends. After the application is downloaded to update data, the USB is informed that the main storage device is removed. Then the work ends.

The externally connected simulation device for loading different operation systems of the present invention is achieved by means of hardware.

The present invention provides a simulating method for loading different operation systems by means of externally connected simulation and a simulation device thereof. The present invention enables a personal computer to simulate different operation systems without being incautiously damaged by a user.

The present invention has five functions, any of which can be selectively executed as follows:

Function 1 including steps to be executed as follows:

1. taking out from advanced configuration & power interface (ACPI) of the system, for example, signing on high memory (service memory) of real mold from the ACPI table and then copying the ACPI to a memory (such as hard disc (HDD), flash, CD-ROM, etc.).

2. copying from the ACPI.

3. modifying all contents of differentiated system description table (DSDT).

4. correcting the ACPI.

5. displaying new location of the ACPI.

Function 2:

When the accessories of the loader do not exist in the virtual kernel model, the kernel for the models is in the cache. They are memorized in such as HDD, flash, CD-ROM, etc. Now there are kernel model A, kernel model B, kernel model C, kernel model D, kernel model E, kernel model F, kernel model G, kernel model H, etc. A certain driver model makes a command as follows: “According to kernel model A, kernel model C and kernel model N (not existing in the example), the kernel model H is required to be loaded into another location or device, (for example, HDD, flash, CD-ROM, etc.)” This can solve the problem that the accessories do not exist in the kernel model N.

Function 3:

In general, the record point is written into and recorded on the hard disc. The present invention directly real-time reads or accesses the data on the hard disc for modification or writing and reads the boot table. All the boot partition types of the computer can be directly displayed without making any action to the hardware.

Function 4:

When the simulation device of the present invention is to be installed on an operation system for use, a sequence of serial numbers are first sent to the operation system. The serial number of the operation system will be registered in the simulation device of the present invention. When someday the same user wants to replace the operation system with a new one, the same simulation device can be reinstalled on the new operation system for use.

Function 5:

Before loading the operation system, the special loader loads steps in which:

1. The non-uniformity between the OS and the ACPI in synchronous operation is corrected. This includes steps of:
(a) initiating the investigation of the root system description pointer (RSDP) table within a special range of the RSDP address, these being 0xe0000-0xfffff of special boot address in the memory;
(b) finding the root system description table (RSDT) in the RSDP table;
(c) finding fixed ACPI description table (FADT) in the RSDT; and
(d) finding DSDT in the FADT.

2. In the memory, the covered range is the DSDT covered by the DSDT.

3. After the DSDT is covered, the kernel of the OS will read the corrected ACPI table when installed.

The kernel model means the kernel of the operation system (not limited).

The above embodiments are only used to illustrate the present invention, not intended to limit the scope thereof. Many modifications of the above embodiments can be made without departing from the spirit of the present invention.

What is claimed is:

1. A simulating method for loading different operation systems by means of externally connected simulation, the simulating method serving to prepare a simulation device, which can be externally inserted to a personal computer to simulate different operation systems, the simulating method comprising steps in which:
(a) the personal computer is booted;
(b) the basic input/output system (BIOS) of the personal computer is started;
(c) by means of the BIOS, the hardware-based simulation device is started, the simulation device being externally inserted to the personal computer to simulate different boot environment so as to load another different operation system;
(d) the hardware-based simulation device simulates a set boot environment;
(e) the hardware-based simulation device is used to boot; and
(f) the necessary operation system is executed.

2. The simulating method for loading different operation systems by means of externally connected simulation as claimed in claim 1, wherein the simulating method is achieved by means of hardware.

3. The simulating method for loading different operation systems by means of externally connected simulation as claimed in claim 1, comprising steps of: taking out from advanced configuration & power interface (ACPI) of the system; copying from the ACPI; modifying all contents of differentiated system description table (DSDT); correcting the ACPI; displaying new location of the ACPI.

4. The simulating method for loading different operation systems by means of externally connected simulation as claimed in claim 1, wherein when accessories do not exist in virtual kernel model, a certain driver model makes a command that the selected kernel model and the virtual kernel model are required to be loaded into another location or device so as to solve the problem that the accessories do not exist in the kernel model.

5. The simulating method for loading different operation systems by means of externally connected simulation as claimed in claim 1, which directly real-time reads or accesses the data on the hard disc for modification or writing and reads the boot table, whereby all the boot partition types of the computer can be directly displayed without making any action to the hardware.

6. The simulating method for loading different operation systems by means of externally connected simulation as claimed in claim 1, wherein when the simulation device is to be installed on an operation system for use, a sequence of serial numbers are first sent to the operation system, the serial number of the operation system being registered in the simulation device, whereby when replacing the operation system with a new one, the same simulation device can be reinstalled on the new operation system for use.

7. The simulating method for loading different operation systems by means of externally connected simulation as claimed in claim 1, wherein before loading the operation system, a special loader loads steps in which:
(A) the non-uniformity between the OS and the ACPI in synchronous operation is corrected, this including steps of:
(a) initiating the investigation of the root system description pointer (RSDP) table within a special range of the RSDP address, these being 0xe0000-0xfffff of special boot address in the memory;
(b) finding the root system description table (RSDT) in the RSDP table;
(c) finding fixed ACPI description table (FADT) in the RSDT; and
(d) finding DSDT in the FADT;]
(B) in the memory, the covered range is the DSDT covered by the DSDT; and
(C) after the DSDT is covered, the kernel of the OS reads the corrected ACPI table when installed.

8. An externally connected simulation device for loading different operation systems, comprising:
(a) a hardware-based boot environment simulator for simulating necessary boot environment by means of hardware, the boot loader being read into a specific section of the memory, then, the boot loader starting preparing, for example, Macintosh installation environment, after the preparation is completed, a user being able to select Macintosh operation system boot, Macintosh software installation or other installation program boot; and
(b) a hardware-based operation system installation environment simulator for simulating necessary operation system installation environment by means of hardware, the program being adapted from real-time mode to 32-bit protection mode, then the handler being set with BIOS function, the software scanner system scanning the memory loaded with the operation system, then the software checking every found partition tables, then the software displaying user list on the screen for a user to select.

9. The externally connected simulation device for loading different operation systems as claimed in claim 8, wherein the simulation device is achieved by means of hardware.
